(19) United States
(12) Patent Application Publication
(10) Pub. No.: US 2021/0208493 A1
(43) Pub. Date: Jul. 8, 2021

(54) PROJECTION DEVICE

(71) Applicant: Coretronic Corporation, Hsin-Chu (TW)

(72) Inventors: Wen-Chieh Chung, Hsin-Chu (TW); Jen-Wei Kuo, Hsin-Chu (TW); Tsung-Hsin Liao, Hsin-Chu (TW)

(73) Assignee: Coretronic Corporation, Hsin-Chu (TW)

(21) Appl. No.: 17/141,225

(22) Filed: Jan. 5, 2021

(30) Foreign Application Priority Data
Jan. 7, 2020 (CN) 202010013432.1

(51) Int. Cl. G03B 33/12; G03B 21/20

(52) U.S. Cl. CPC G03B 33/12; G03B 21/2013; G03B 21/16; G03B 21/208; G03B 21/2066

(57) ABSTRACT

A projection device including a light combining system, an illumination system, and a projection lens is provided. The light combining system is configured to provide a combined beam. The illumination system is disposed on a transmission path of the combined beam and configured to receive the combined beam to generate an illumination beam. At least one light valve is disposed on a transmission path of the illumination beam and converts the illumination beam into an image beam. The projection lens is disposed on a transmission path of the image beam and configured to project the image beam out of the projection device. The light combining system is located in a first layer space. The at least one light valve is located in a second layer space. The first layer space is different from the second layer space. The first layer and second layer spaces overlap in the gravitational direction.

### CROSS-REFERENCE TO RELATED APPLICATION

This application claims the priority benefit of China application serial no. 202010013432.1, filed on Jan. 7, 2020. The entirety of the above-mentioned patent application is hereby incorporated by reference herein and made a part of this specification.

### BACKGROUND

### Technical Field

The disclosure relates to a display device, and in particular, to a projection device.

### Description of Related Art

The projection device is a type of display device configured to generate large-size images. With the evolution and innovation of science and technology, the projection device has been continuously improving. The imaging principle of the projection device is to convert the illumination beam generated by an illumination system into an image beam by a light valve, and then project the image beam to a projection target (such as a screen or a wall) through a projection lens to form a projection image.

Generally speaking, the light source, the light combining element, the lens module, the light valve, and other components are disposed in the same layer in the casing of the projection device. However, such an arrangement of components will cause the projection device to require a larger space in the horizontal direction, so the projection device will have a larger volume. However, in the case where the components are compressed to reduce the size of the projection device, it is difficult for the cooling airflow to flow through the space between the components, so some components may generate high temperatures and have lower heat dissipation efficiency, such that the optical effect is affected by the heat.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the invention was acknowledged by a person of ordinary skill in the art.

### SUMMARY

The disclosure provides a projection device, which can effectively balance the miniaturization of the projection device and can have a good heat dissipation effect.

Other objectives and advantages of the disclosure can be further understood from the technical features disclosed by the disclosure.

In order to achieve one, a part, or all of the objectives or other objectives, an embodiment of the disclosure provides a projection device, which includes a light combining system, an illumination system, at least one light valve, and a projection lens. The light combining system is configured to provide a combined beam. The illumination system is disposed on a transmission path of the combined beam and is configured to receive the combined beam to generate an illumination beam. The at least one light valve is disposed on a transmission path of the illumination beam and is configured to convert the illumination beam into an image beam. The projection lens is disposed on a transmission path of the image beam and is configured to project the image beam out of the projection device, wherein the light combining system is located in a first layer pace and the at least one light valve is located in a second layer space. The first layer space is different from the second layer space, and the first layer space and the second layer space overlap in the gravitational direction.

In order to achieve one, a part, or all of the objectives or other objectives, another embodiment of the disclosure provides a projection device, which includes a light combining system, an illumination system, at least one light valve, and a projection lens. The light combining system is configured to provide a combined beam. The illumination system is disposed on a transmission path of the combined beam and is configured to receive the combined beam to generate an illumination beam. The at least one light valve is disposed on a transmission path of the illumination beam and is configured to convert the illumination beam into an image beam. The projection lens is disposed on a transmission path of the image beam and is configured to project the image beam out of the projection device, wherein the least one light valve is located in a first layer space and the light combining system is located in a second layer space. The first layer space is different from the second layer space, and the first layer space and the second layer space overlap in the gravitational direction.

Based on the above, the embodiments of the disclosure have at least one of the following advantages or effects. In the projection device of the disclosure, the light combining system is located in the first layer space and the light valve is located in the second layer space.

The first layer space is different from the second layer space, and the first layer space and the second layer space overlap in the gravitational direction. In another projection device of the disclosure, the light valve is located in the first layer space and the light combining system is located in the second layer space. The first layer space is different from the second layer space, and the first layer space and the second layer space overlap in the gravitational direction. In addition, the combined beam provided by the light combining system may be transmitted to the light valve located in a different layer space from the light combining system by the illumination system. Therefore, the space of the projection device in the horizontal direction can be reduced, thereby reducing the volume of the projection device. In addition, since the overall structure of the projection device is reduced, the heat dissipation efficiency of the heat dissipation module can be further improved. In this way, it is possible to effectively balance the miniaturization of the projection device and to have a good heat dissipation effect.

Other objectives, features and advantages of the present invention will be further understood from the further technological features disclosed by the embodiments of the present invention wherein there are shown and described preferred embodiments of this invention, simply by way of illustration of modes best suited to carry out the invention

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view of a projection device according to an embodiment of the disclosure.

FIG. 2 is a perspective view of the projection device of FIG. 1.

FIG. 3A is a perspective view of parts of the projection device in FIG. 2 from a perspective.

FIG. 3B is a perspective view of the parts of the projection device in FIG. 2 from another perspective.

FIG. 4 is a top view of the parts of the projection device in FIG. 2.

FIG. 5 is a perspective view of a projection device according to another embodiment of the disclosure.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

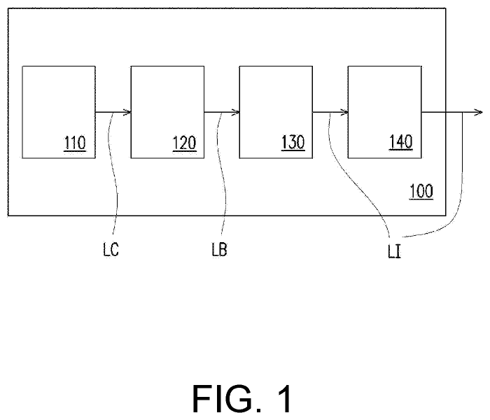

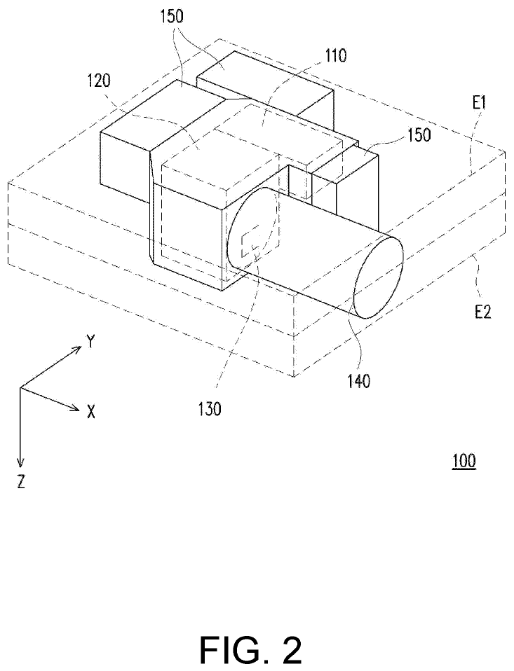

FIG. 1 is a schematic view of a projection device according to an embodiment of the disclosure. FIG. 2 is a perspective view of the projection device of FIG. 1. Please refer to FIG. 1 and FIG. 2. The embodiment provides a projection device 100 including a light combining system 110, an illumination system 120, at least one light valve 130, and a projection lens 140. The light combining system 110 is configured to provide a combined beam LC. The illumination system 120 is disposed on a transmission path of the combined beam LC and is configured to receive the combined beam LC to generate an illumination beam LB. The at least one light valve 130 is disposed on a transmission path of the illumination beam LB and is configured to convert the illumination beam LB into an image beam LI. The projection lens 140 is disposed on a transmission path of the image beam LI and is configured to enlarge and project the image beam LI out of the projection device 100 to be projected to a projection target (not shown), such as a screen or a wall, but is not limited thereto. In the embodiment, the projection device 100 is further disposed with a plurality of heat dissipation modules 150, respectively connected to the light combining system 110, the illumination system 120, and the at least one light valve 130 for heat dissipation. The heat dissipation module 150 includes a plurality of fins and a plurality of heat pipes (not shown), but the disclosure does not limit the quantity and type of the heat dissipation module 150.

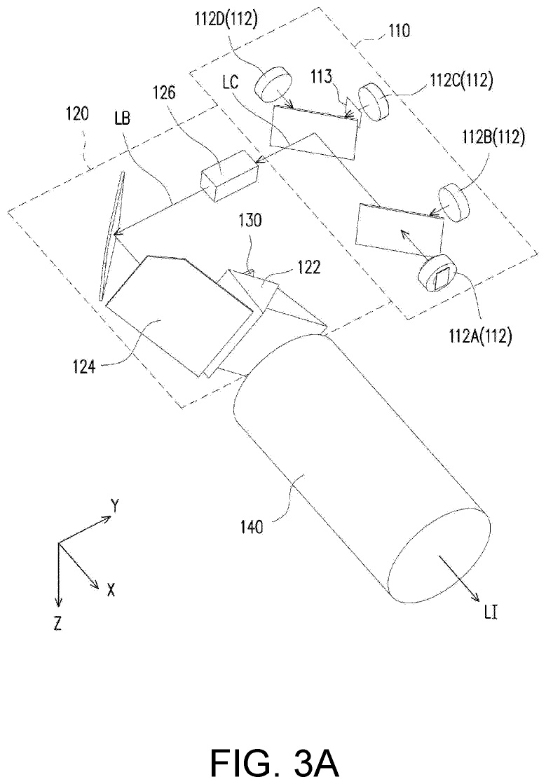

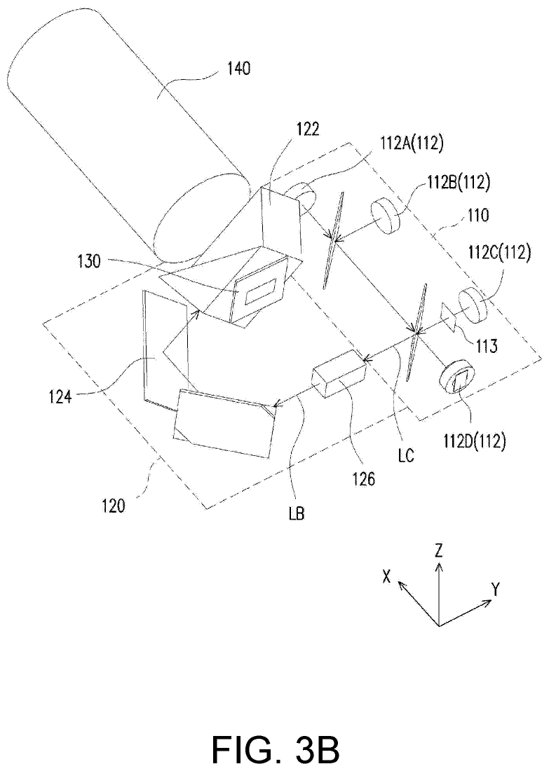

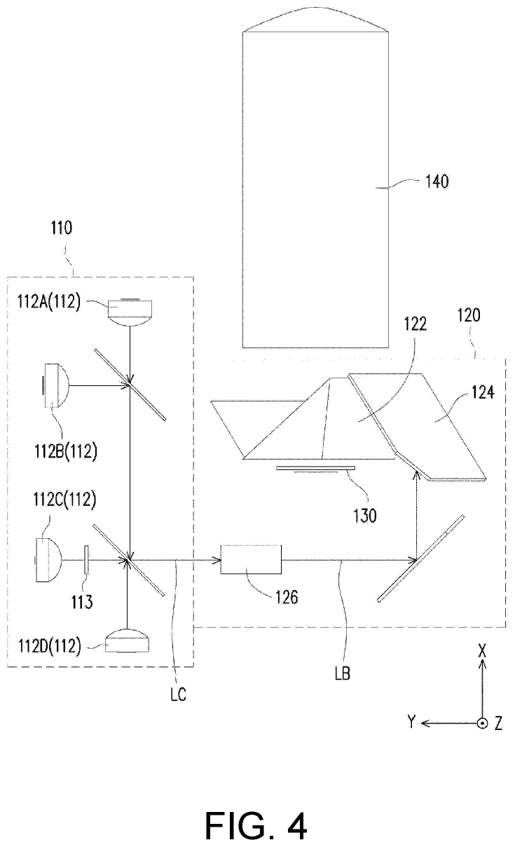

FIG. 3A is a perspective view of parts of the projection device in FIG. 2 from a perspective. FIG. 3B is a perspective view of the parts of the projection device in FIG. 2 from another perspective. FIG. 4 is a top view of the parts of the projection device in FIG. 2. Please refer to FIG. 2 to FIG. 4. A light combining system 110 is, for example, formed from a combination of a plurality of light emitting elements, a wavelength conversion element, a filter element, and a plurality of light splitting and combining elements, and is configured to provide light of different wavelengths as a source of an image light. However, the disclosure does not limit the type or form of the light combining system 110 in the projection device 100. In detail, in the embodiment, the light combining system 110 includes a plurality of light sources 112, and the light sources 112 are configured to respectively provide a plurality of beams, such that the plurality of beam is combined to form a combined beam LC. The plurality of light sources 112 are, for example, a solid-state illumination device (S SI), a laser diode, an array of laser diodes, a light emitting diode, or an array of light emitting diodes, and the quantity is not limited.

For example, the light combining system 110 includes a red light source 112A, a blue light source 112B, a first excitation light source 112C, and a second excitation light source 112D. In the embodiment, the blue light source 112B may be disposed between the red light source 112A and the first excitation light source 112C. Therefore, the red light source 112A may be closer to an air inlet or an air outlet of the casing of the projection device 100 to improve the heat dissipation effect of the red light source 112A, but the disclosure is not limited thereto. In the embodiment, the light emitting direction of the red light source 112A is perpendicular to the light emitting direction of the blue light source 112B, and the light emitting direction of the first excitation light source 112C is perpendicular to the light emitting direction of the second excitation light source 112D. It is worth mentioning that the blue excitation beam emitted from the first excitation light source 112C and the blue excitation beam emitted from the second excitation light source 112D have the same wavelength range. All the blue excitation beams generated by the first excitation light source 112C and the second excitation light source 112D are irradiated to a wavelength conversion layer 113. The wavelength conversion layer 113 is, for example, a phosphor powder layer. The blue excitation beams are irradiated to the wavelength conversion layer 113, and the wavelength conversion layer 113 is excited by the blue excitation beams to generate a green beam. The combined beam LC may be composed of at least one of a red beam, a blue beam, and a green beam.

The illumination system 120 includes a light homogenizing element 126, disposed on a transmission path of the combined beam LC and configured to receive the combined beam LC to output an illumination beam LB. The light homogenizing element 126 is configured to adjust the spot shape of the beam, such that the spot shape of the beam is coordinated with the shape (for example, rectangular) of the working area of the light valve 130 and the light spot has consistent or close light intensity everywhere on the light valve, homogenously illuminating the light intensity of the beam. In the embodiment, the light homogenizing element 126 is, for example, an integration rod, but in other embodiments, the light homogenizing element 126 may also be another suitable form of optical element, such as a lens array (fly eye lens array), and the disclosure is not limited thereto.

The at least one light valve 130 is, for example, a reflective light modulator such as a digital micro-mirror device (DMD), a liquid crystal on silicon panel (LCoS panel), etc. In some embodiments, the light valve 130 may also be a transmissive light modulator such as a transparent liquid crystal panel, an electro-optic modulator, a magneto-optic modulator, an acousto-optic modulator (AOM), etc. In the embodiment, the light valve 130 is, for example, a reflective light valve, but the disclosure does not limit the form and type of the light valve 130. Sufficient teachings, suggestions, and implementation explanations of the detailed steps and implementations of the method of converting the illumination beam LB into the image beam LI by the light valve 130 may be obtained from common knowledge in the art, so there will be no reiteration here. In the embodiment, the quantity of the light valves 130 is one, for example, the projection device 100 uses a single digital micro-mirror element, but in other embodiments, the quantity may be multiple, and the disclosure is not limited thereto.

The projection lens 140 includes, for example, a combination of one or more optical lenses having refractive power, such as various combinations including non-planar lenses such as a biconcave lens, a biconvex lens, a concave-convex lens, a convex-concave lens, a plano-convex lens, and a plano-concave lens. In the embodiment, the projection lens 140 may further include a planar optical lens and project the image beam LI from the light valve 130 to the projection target in a reflective manner. The disclosure does not limit the form and type of the projection lens 140. In addition, in some embodiments, the projection device 100 may also optionally include optical elements such as a beam splitter for separating beam of specific wavelength, a reflector, etc. The reflector may be configured, for example, to guide the illumination beam LB emitted by the illumination system 120 to the light valve 130. However, the disclosure is not limited thereto. In other embodiments, other optical elements may be used to guide the illumination beam LB to the light valve 130.

In the embodiment, the projection device 100 has a first layer space E1 and a second layer space E2. The light combining system 110 is located in the first layer space E1 and the at least one light valve 130 is located in the second layer space E2, as shown in FIG. 2. The first layer space E1 is different from the second layer space E2, and it is defined that the first layer space E1 and the second layer space E2 overlap in the gravitational direction (that is, the Z direction). In other words, the light combining system 110 and the light valve 130 are located in different layer spaces in the Z direction. Therefore, the space of the projection device 100 in the horizontal direction (that is, the X-Y direction) can be reduced, thereby reducing the overall volume of the projection device 100. In addition, since the overall structure of the projection device 100 is reduced, it is possible to improve the heat dissipation efficiency of the heat dissipation module 150. In this way, it is possible to effectively balance the miniaturization of the projection device 100 and to have a good heat dissipation effect.

In the embodiment, in the Z direction, the projection position of at least a portion of the illumination system 120 on the X-Y plane in the second layer space E2 overlaps with the position of the light valve 130, but the disclosure is not limited thereto. In addition, the projection lens 140 is located in the first layer space E1 and the second layer space E2. In other words, the projection lens 140 overlaps with at least a portion of the illumination system 120 and the light valve 130 on the Y-Z plane. The orthographical projection of the projection lens 140 on the X-Z plane overlaps with at least a portion of the light combining system 110.

On the other hand, in the embodiment, the illumination system 120 and the light valve 130 are sequentially arranged along the gravitational direction. That is, at least a portion of the illumination system 120 is located above the light valve 130 and the combined beam LC provided by the light combining system 110 is transmitted to the light valve 130 located below at least a portion of the illumination system 120. However, in the embodiment, the light valve 130 and the illumination system 120 are sequentially arranged along the gravitational direction (that is, the Z direction). That is, at least a portion of the illumination system 120 is located below the light valve 130 and the combined beam LC provided by the light combining system 110 is transmitted to the light valve 130 located above at least a portion of the illumination system 120, and the disclosure is not limited thereto.

In detail, in the embodiment, the illumination system 120 further includes a prism module 122 and at least one reflective element 124, wherein the combined beam LC from the light combining system 110 is transmitted to the light homogenizing element 126, the light homogenizing element 126 converts the combined beam LC into the illumination beam LB, and the illumination beam LB is reflected by the at least one reflective element 124. The reflective element 124 is configured to bend the transmission path of the illumination beam LB, such that the transmission direction of at least a portion of the illumination beam LB is parallel to the transmission direction of the image beam LI. In addition, the reflective element 124 reflects the illumination beam LB located in the first layer space E1 to the prism module 122, the prism module 122 then transmits the illumination beam LB to the light valve 130, and the light valve 130 converts the illumination beam LB into the image beam LI, which passes through the prism module 122 and is projected out of the projection device 100 by the projection lens 140.

In this way, the illumination system 120 with different light transmission paths may be further planned and designed, thereby reducing the volume of the projection device 100, but the disclosure is not limited thereto. In different embodiments, the reflective element 124 may also be disposed in the light combining system 110 to further plan and design the light combining system 110 with different light transmission paths, thereby reducing the volume of the projection device 100, but the disclosure is not limited thereto.

On the other hand, the prism module 122 is located in the first layer space E1 and the second layer space E2. In other words, the prism module 122 extends within the first layer space E1 and the second layer space E2, so that the illumination beam LB provided by the light homogenizing element 126 may be guided and transmitted from the first layer space E1 to the second layer space E2. In this way, the combined beam LC provided by the light combining system 110 may be transmitted by the illumination system 120 to the light valve 130 located in a layer space different from the light combining system 110. In the embodiment, an extension direction of the prism module 122 is inclined to the gravitational direction, for example, the extension direction is 30 to 60 degrees off from the gravitational direction. The configurational method and the quantity of different configurational positions of the light valve 130 in the second layer space E2 may be further increased, but the disclosure is not limited thereto.

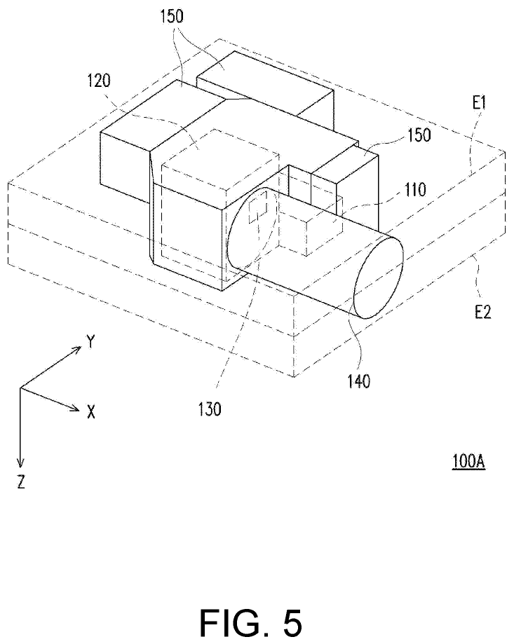

FIG. 5 is a perspective view of a projection device according to another embodiment of the disclosure. Please refer to FIG. 5. A projection device 100A of this embodiment is similar to the projection device 100 of the embodiment of FIG. 2. The difference between the two is that, in this embodiment, a light combining system 110 and a portion of an illumination system 120 of the projection device 100A are disposed in a second layer space E2, and a light valve 130 is disposed in a first layer space E1. In other words, the light combining system 110 is located below the light valve 130 and the illumination system 120 uses a prism (not shown) located in the first layer space E1 and the second layer space E2 to guide and transmit illumination beam LB provided by a light homogenizing element (not shown) from the second layer space E2 to the light valve 130 in the first layer space E1. In this way, when the light valve 130 is in an off-state, the light valve 130 reflects the illumination beam LB to a light absorbing area (not shown) from top to bottom, thereby reducing the light leakage phenomenon of the projection device 100A in the black screen state while also improving the image contrast.

In addition, as shown in FIG. 2, FIG. 3A, FIG. 3B, and FIG. 4, in the embodiments of the disclosure, the entire light combining system 110 is presented as a rectangular shape (when viewed from the gravitational direction) and the long sides of the light combining system 110 are parallel to the optical axis (not shown) of the projection lens 140, which are both parallel to the X direction, wherein the optical axis is defined as the direction of the main beam path of the image beam. With the above arrangement, the light combining system 110, the illumination system 120, and the projection lens 140 are arranged into a U-shaped optical structure inside of the projection device, thereby effectively reducing the overall volume of the projection device.

Based on the above, the embodiments of the disclosure have at least one of the following advantages or effects. In the projection device of the disclosure, the light combining system is located in the first layer space and the light valve is located in the second layer space. The first layer space is different from the second layer space, and the first layer space and the second layer space overlap in the gravitational direction. Therefore, the space occupied by the projection device in the horizontal direction can be reduced, thereby reducing the volume of the projection device. In addition, since the overall structure of the projection device is reduced, the heat dissipation efficiency of the heat dissipation module can be further improved. In this way, it is possible to effectively balance the miniaturization of the projection device and to have a good heat dissipation effect.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A projection device, comprising a light combining system, an illumination system, at least one light valve, and a projection lens, wherein
the light combining system is configured to provide a combined beam;
the illumination system is disposed on a transmission path of the combined beam and is configured to receive the combined beam to generate an illumination beam;
the at least one light valve is disposed on a transmission path of the illumination beam and is configured to convert the illumination beam into an image beam; and
the projection lens is disposed on a transmission path of the image beam and is configured to project the image beam out of the projection device, wherein the light combining system is located in a first layer space, the at least one light valve is located in a second layer space, the first layer space is different from the second layer space, and the first layer space and the second layer space overlap in a gravitational direction.

2. The projection device according to claim 1, wherein a projection position of at least a portion of the illumination system in the second layer space overlaps with a position of the at least one light valve.

3. The projection device according to claim 1, wherein the projection lens is located in the first layer space and the second layer space.

4. The projection device according to claim 1, wherein the illumination system and the at least one light valve are sequentially arranged along the gravitational direction.

5. The projection device according to claim 1, wherein the illumination system comprises a prism module, and the prism module is located in the first layer space and the second layer space.

6. The projection device according to claim 5, wherein an extension direction of the prism module is inclined to the gravitational direction.

7. The projection device according to claim 1, wherein the illumination system comprises a reflective element for bending the transmission path of the illumination beam.

8. The projection device according to claim 1, wherein the illumination system comprises a light homogenizing element, which is disposed on the transmission path of the combined beam and is configured to receive the combined beam to generate the illumination beam.

9. The projection device according to claim 1, wherein the light combining system comprises a plurality of light sources, configured to provide a plurality of beams to form the combined beam.

10. The projection device according to claim 1, wherein the light combining system comprises a red light source, a blue light source, a first excitation light source, and a second excitation light source, wherein the blue light source is disposed between the red light source and the first excitation light source.

11. The projection device according to claim 1, wherein the at least one light valve is a reflective light valve.

12. The projection device according to claim 1, wherein a quantity of the at least one light valve is one.

13. A projection device, comprising a light combining system, an illumination system, at least one light valve, and a projection lens, wherein
the light combining system is configured to provide a combined beam;
the illumination system is disposed on a transmission path of the combined beam and is configured to receive the combined beam to generate an illumination beam;
the at least one light valve is disposed on a transmission path of the illumination beam and is configured to convert the illumination beam into an image beam; and
the projection lens is disposed on a transmission path of the image beam and is configured to project the image beam out of the projection device, wherein the at least one light valve is located in a first layer space, the light combining system is located in a second layer space, the first layer space is different from the second layer space, and the first layer space and the second layer space overlap in a gravitational direction.

14. The projection device according to claim 13, wherein the at least one light valve and the illumination system are sequentially arranged along the gravitational direction.
